(19) United States
(12) Patent Application Publication
(10) Pub. No.: US 2013/0218059 A1
(43) Pub. Date: Aug. 22, 2013

(54) SENSITIVE AND STIMULATING THERAPEUTIC DEVICE

(71) Applicant: Mario Cerioli, Castelleone (CR) (IT)

(72) Inventor: Mario Cerioli, Castelleone (CR) (IT)

(21) Appl. No.: 13/881,775

(22) PCT Filed: Oct. 24, 2011
(86) PCT No.: PCT/IT2011/000359

§ 371 Date: Apr. 26, 2013

(30) Foreign Application Priority Data
Oct. 26, 2010 (IT) CR2010A000034

(51) Int. Cl. A61H 15/00

(52) U.S. Cl. CPC A61H 15/0078
USPC 601/116

(57) ABSTRACT

A sensitive and stimulating therapeutic device for postural and locomotory rehabilitation of subjects with disabilities includes a fixed base, mobile support elements, transmission elements arranged between the base and the support elements, motor element (5) cooperating with the transmission elements to produce in the mobile support elements an angular rotation movement reversible on an axis parallel to the cephalocaudal body axis of a subject, a control unit with a non-volatile memory and a data processing device, for controlling the motor element. The mobile support elements include: a frame kinematically connected to the transmission elements, a swinging support surface connected to the frame by a median fulcrum blade parallel to the rotation axis, on which the surface swings and by at least one weight transducer arranged to detect the weight variation produced by a movement of the subject and to transmit it to the control unit, for processing.

The present invention relates to a sensitive and stimulating therapeutic device for postural and locomotory rehabilitation of subjects with disabilities, in particular for children with a motor skills development disorder due to brain damage, malformations, etc.

One of the most significant consequences of brain damage is the trouble in learning postural adjustments, i.e. the motor activities that allow control of the body towards an actual move, such as to grab an object, to roll from the supine to the prone position and vice versa, or to stand up etc.

A little child suffering from motor skills development disorder remains motionless even for four or five hours a day, thus ending up in not learning how to use his/her own body and not expressing part of his/her potentials.

Said child shows the greatest difficulty in performing movements that imply variation and raising the centre of his/her body mass with respect to the support surface.

During growth, a child with motor skills development disorder tends to perform less and less movements that are difficult for him/her: his/her initiatives are not crowned with success, therefore reducing both his/her chance of development and his/her range of activities.

The rehabilitation methods for the motor skills development disabilities in use nowadays are based on manual manoeuvres carried out by rehabilitation professionals, by the child's parents or by volunteers and comprise some non-intensive treatment methods (such as Vojta, Bobath,

Neuro-evolutive Treatment, Puccini-Perfetti, etc.) and other methods which provide for an intensity up to 12 hours a day (e.g. Doman and variants).

The rehabilitation methods based on the mere manual manoeuvres, which must be repeated for a long time and must be very intense, are disadvantageously approachable only to families with a strong motivation, with considerable financial possibilities, and who can rely on the co-operation of many people and volunteers. Furthermore, these methods do not suitably optimize the aim of the stimulation for favouring a supposed but not suitably documented reflexed automatization of said stimulation.

Besides, since said treatments last for the whole day and are carried out by different persons, they are not homogeneous and they are difficult to plan and to control so as to define a personalized therapy and to verify the effects thereof.

Further assistance techniques make use of technological aids, such as the hyperbaric chamber, electrical stimulations, “spacesuits” according to Adeli's method.

It is furthermore known, from the Italian patent No. IT0001321559 of the same applicant, a therapeutic device “cradle” shaped, made of a mobile support with semi cylindrical section on the inner surface of which the child swing or rolls, according to the width of the angular rotation motion back and forth mechanically imposed to said support by means of suitable motor means provided with reversible direction of rotation.

Said swinging motion takes place on an axis parallel to the cephalocaudal body axis of the child, in order to make the position of the centre of his/her body mass change with respect to the support surface.

Besides, said device further comprises control means arranged for adjusting in a pre-set way the speed, the width and the length in time of the swinging motion of the mobile support.

The device provides for the stimulation motions actually provided to be recorded in their speed, width and length in time, so as to be then compared to the results obtained, and stored in a series of pre-set treatment programs.

Methods that use technological aids, as well as the therapeutical device already patented by said applicant, disadvantageously refer to a passive condition of the child, who simply receives the outer stimulations, but does neither control them nor facilitate nor suggest them; not even the aids can detect the child's movements and react to them in a pre-set way.

Aim of the present invention is instead to eliminate or reduce the above mentioned limits, typical of the rehabilitation methods for the motor skills development disabilities in use at present, which are “passivating” towards the child and which do not make the most of the movement thereof.

In particular the main aim of the present invention is to realize a sensitive mechanical device, i.e. “active”, and stimulating that allows to provide the child with prolonged variations of the position of his/her body with respect to the force of gravity, oscillations and rotations, according to an approach of the cognitive type and centered on the utilization of the child's initiative in his/her normal life environment.

Therefore aim of the present invention is also to realize a device that operates according to the needs and to the kind of reaction or inputs to the motion implemented by the child himself/herself.

It is further aim of the present invention to arrange a system that allows to store the inputs implemented by the child in time, providing for a method that correlates said stimula and the results actually obtained.

Further aim is to realize a device that provides for three different working methods:
of the sensitive type, automatically correlated to the child's movements;
of the manual type, with the intervention of an adult that operates it at his/her discretion;
of the continuous automatic type, according to pre-set motion programs.

Finally, the device will be usable by non-professional operators, at home, but also by professionals for an evaluation-diagnostic purpose, i.e. for setting the treatment program and for checking the child's evolution.

Said aims are reached by means of a sensitive and stimulating device for postural and locomotory rehabilitation of a subject with disabilities, comprising:
a fixed base;
mobile support means arranged for supporting the disabled subject;
transmission means arranged between said base and said support means;
motor means arranged for cooperating with said transmission means to produce in said mobile support means a angular rotation movement reversible on an axis parallel to the cephalocaudal body axis of said disabled subject;
a control unit provided with a non-volatile memory and with a data processing device, arranged for controlling said motor means, characterized in that said mobile support means comprise:
a frame kinematically connected to said transmission means;
a swinging support surface which supports the disabled subject,
   wherein said swinging support surface is connected to said frame by means of a median fulcrum blade parallel to said rotation axis, on which said surface swings and by means of at least one weight transducer,
   wherein said transducer is arranged for detecting the variation in weight produced by a movement of the disabled subject and to transmit it to said control unit, which processes it and controls said motor means according to pre-set response programs resising in said non-volatile memory.

According to a first embodiment of the present invention said mobile support means comprise a plurality of elastically yielding support feet, interposed between said surface and said frame, in order to make the connection thereof steady.

According to a further embodiment of the present invention, said transducer does not belong to the axis of said fulcrum blade, in order to be more sensitive.

According to further embodiments of the present invention, said swinging support surface comprises two lateral sidewalls and said frame comprises at least one arc-shaped cross guide, arranged for slidingly engaging at least one pair of wheels associated with said fixed base.

Advantageously, said transmission means comprise a selectively activated clutch placed downstream of said motor means, and said device further comprises manual movement means of said transmission means.

The advantages obtained with the present invention consist in the possibility to carry out a therapy based on stimula suitably adapted according to the child's intention manifested by the movement, even slightest, of his/her mass centre detected by the transducer arranged under the swinging surface that supports the disabled subject.

The cooperation between the support surface swinging around a blade fulcrum and the weight transducer, which connects one to the other the frame and the swinging surface that supports the child, allows to determine the direction of the movement of the child's mass center and allows the control unit to produce a consequent rotation of the mobile support means.

This way, the afferents typical of the extrauterine gravity environment, which can solicit and stimulate the child's adapting postural reactions, are generated, said reactions being directed towards keeping the sight contact with the surrounding environment and reaching the objects around him/her.

The device does not limit the child's view: in fact the mobile support means are very wide and low so as to allow said child to observe the persons and the objects in the surrounding environment and to let the persons that assist the child to thoroughly check his/her activity.

Besides, the device can be provided with toys or any other thing that can safely awaken the child's interest and initiative.

The device is simple to activate: it can be easily used at the child's house, by his/her parents, after suitable training.

In a first possible embodiment, the therapeutic device can be automatically moved by the motor means, after having programmed the reaction sensitivity thereof to the pre-set minimum weight variation and after having memorized the width of the angle of rotation and the angular speeds.

In a second embodiment, instead, the therapeutic device can be manually moved, disconnecting the motor means from the transmission means by means of the clutch, and operating on the transmission means by means of a crank, in order to introduce more targeted postural control tasks to the child, proposed by the adult in charge.

In a third embodiment, the therapeutic device can be automatically moved, according to programs that are pre-set by the subject in charge, regardless of the child's movements.

The sensitive device supplies afferents that are not only vestibular or visual, but also vibratory which, as it is known, aid the muscular activities.

The advantages of the present invention shall appear more clearly from the following description of preferred embodiments, made by way of indicative and non-limiting examples, with reference to the figures, wherein:

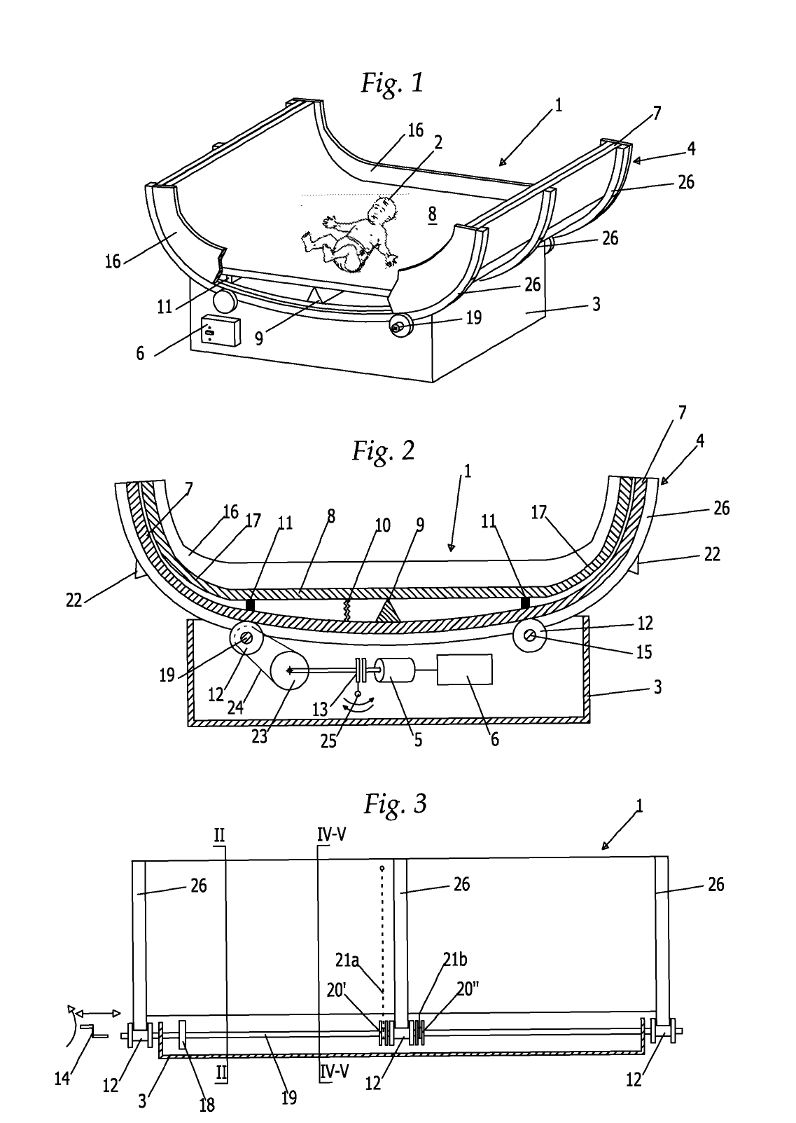

FIG. 1 shows an axonometric view of a sensitive and stimulating therapeutic device for postural and locomotory rehabilitation realized according to the present invention;

FIG. 2 shows a schematic cross section of the device according to FIG. 1;

FIG. 3 shows the device of FIG. 1, according to a lateral longitudinal partially sectioned view;

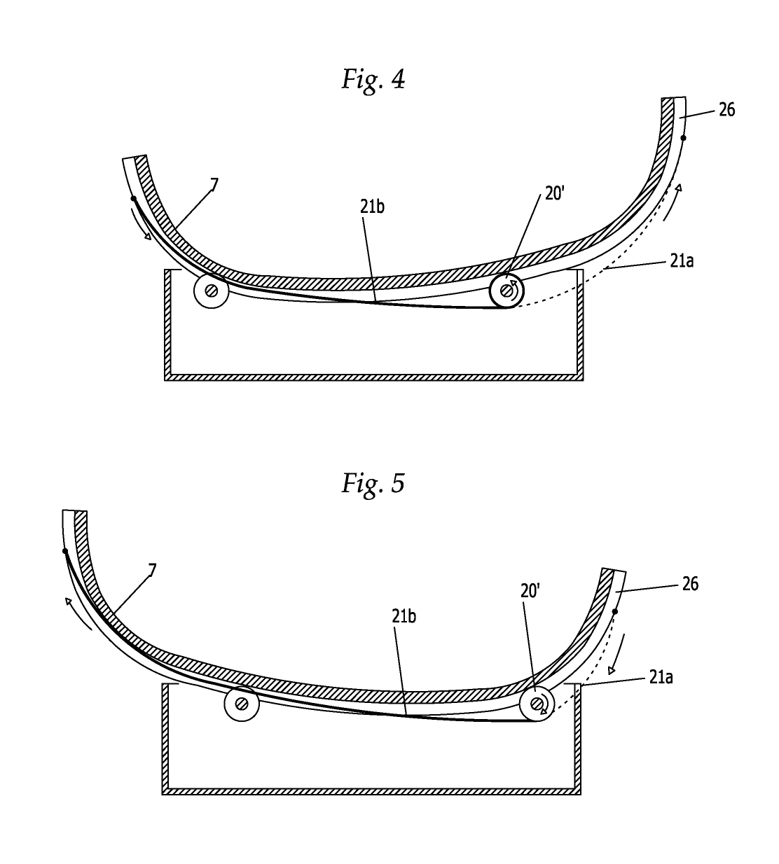

FIGS. 4 e 5 schematically show, according to a cross section, two different positions taken by the device when working.

With reference to the embodiment shown in the figures, the device 1 comprises a fixed base 3, mobile support means 4 arranged for supporting a disabled subject 2, motion transmission means, motor means 5 and a control unit 6.

In particular said mobile support means 4 comprise a frame 7 kinematically connected to said transmission means and a swinging support surface 8 that support the disabled subject 2.

The surface 8 comprises two lateral concave sidewalls 17 and raised edges 16 in order to create a protective shell arranged for containing the subject 2.

With particular reference to the device 1 shown, said frame 7 comprises three arc-shaped guides 26, arranged at regular intervals along the longitudinal median axis of the device, which is thus parallel to the cephalocaudal body axis of the subject 2.

Said surface 8 is connected to said frame 7 by means of a median fulcrum blade 9 parallel to said longitudinal axis, and on which the surface 8 rests and can swing, and a weight transducer 10.

Said weight transducer 10 is arranged beside said blade 9, on the right or left side indifferently, and is connected to said control unit 6. Nevertheless, the transducer 10 can also be placed along the axis of the fulcrum blade 9.

Said weight transducer 10 is of the load cell or dynamometer known type.

Furthermore, a plurality of elastically yielding support feet 11 are interposed between said surface 8 and said frame 7. Said feet 11 are made out of rubber or expanded material and are advantageously arranged symmetrically to said fulcrum blade 9.

Said control unit 6 comprises a non-volatile memory and a data processing device, and is arranged for controlling said motor means 5 of the electric type.

Said motor means 5 are arranged for cooperating with said transmission means for inducing in said mobile support means 4 an angular rotation movement reversible to both directions of rotation on said longitudinal axis of the device.

In particular said transmission means comprise:
a motor wheel 18 splined to a transmission shaft 19;
six idle wheels 12, three of which are associated to said transmission shaft 19 and the other three are associated to a corresponding idle shaft 15 parallel thereto;
two wheels 20′ and 20″ splined to said transmission shaft 19 and arranged symmetrically to one of said idle wheels 12;
two belts 21a and 21b, having a first end, each first end being rispectively associated to said splined wheels 20′ and 20″ and a second end steadily associated to said frame 7.

Said driving wheel 18 is connected to said motor means 5 by means of a pulley 23 and belt 24 kinematic motion and a clutch 13, which can be selectively activated by a lever 25, necessary for making the device work in manual mode.

In this case the transmission shaft 19 is moved by a crank 14, as shown in FIG. 3.

Said six idle wheels 12 advantageously are provided with a central groove in which the guides 26 protruding from the frame 7 slidingly engage.

Also said splined wheels 20′ and 20″ are provided with a central groove in which said belts 21a and 21b wind up.

Limit switch sensors (not shown), which can be mechanical as well as of the electronic type, placed between the base and the mobile support means, are activated by limiting devices 22 and stop the rotation of the support means 4 in both directions.

In particular, FIGS. 4 and 5 schematically show the working of the mobile support means 4 of the device.

In particular, the motor means 5 activate the transmission shaft 19 through the pulley 23, the belt 24 and the driving wheel 18 making it rotate in the correct direction set by the control unit 6 according to the signals coming from the weight transducer 10.

The rotation of said transmission shaft 19 alternately causes unwinding of a belt 21a and tightening of the other belt 21b, in such a way that, being associated to the frame, they pull it towards one direction or the other.

In particular, with reference to FIG. 4, since the transmission belt 19 rotates anticlockwise, the belt 21a is tightened, while the belt 21b is loosen: the device 1 rotates of a certain angle on its own median axis and it too tilts anticlockwise.

With reference to FIG. 5, on the other hand, since the transmission belt 19 rotates clockwise, the belt 21a is loosen, while the belt 21b is tightened: the device 1 rotates on its own median axis but tilts clockwise.

According to the present invention the device works as follows.

The operator carries out the following operations:
activates the device 1 by means of a switch;
sets the threshold of sensitivity of the transducer 10 into the control unit;
positions the subject 2 on the surface 8 at the centre of the device 1 so that the cephalocaudal body axis of the subject is parallel to the longitudinal axis of the device itself.

At this point the subject 2 is free to move.

In case of a weight variation, higher than the pre-set threshold of sensitivity, induced by a minimum displacement of the body mass centre of said subject, the motor means 5 start in order to follow heist/her intention: if the subject moves to the right, the mobile support means 4 will rotate of a certain angle in order to tilt the swinging support surface 8 too to the right, so as to enhanve his/her initiative.

In particular, the transducer 10 transmits the weight value detected to the control unit 6, the control unit 6 processes it comparing it to the weight previously detected and, depending on the overcoming of the set activation threshold, it controls the motor means 5 accordingly and the latter activate the rotation, in one direction or the other, of the mobile support means 4 of the device 1.

After a defined operating time, during which the device 1 remains rotated depending on the intention of the subject 2, according to the operating program chosen, either the motor means 5 reactivate and the opposite movement takes place, or the weight transducer 10 reactivates and the device 1 awaits for the following variation of position of the body mass centre of the subject in order to act accordingly.

The presence of limit switches, which can be both mechanical and of the electronic type, limits the rotation of the surface 8 in both directions.

The present invention, as described and illustrated, allows to reach the aims and the objectives set forth.

Practically, without prejudice to the principles of the invention, all the construction details may be substituted with others technically equivalent, as well as the materials, the shapes and the dimentions may be varied according to the needs, without straying from the scope of the present invention.

1. A sensitive and stimulating therapeutic device (1) for postural and locomotory rehabilitation of a subject (2) with disabilities, comprising:
a fixed base (3);
mobile support means (4) arranged for supporting the disabled subject;
transmission means (12, 13, 18, 19, 20, 21, 23 and 24) arranged between said base (3) and said support means (4);
motor means (5) arranged for cooperating with said transmission means to produce in said mobile support means (4) an angular rotation movement reversible on an axis parallel to the cephalocaudal body axis of said disabled subject;
a control unit (6) provided with a non-volatile memory and with a data processing device, arranged for controlling said motor means (5),
characterized in that said mobile support means (4) comprise:
a frame (7) kinematically connected to said transmission means;
a swinging support surface (8) which supports the disabled subject (2),
wherein said swinging support surface (8) is connected to said frame (7) by means of a median fulcrum blade (9) parallel to said rotation axis, on which said surface swings and by means of at least one weight transducer (10),
wherein said transducer (10) is arranged for detecting the variation in weight produced by a movement of the disabled subject (2) and to transmit it to said control unit (6), which processes it and controls said motor means (5) according to pre-set response programs residing in said non-volatile memory.

2. A device (1) according to claim 1, characterized in that said mobile support means (4) comprise a plurality of elastically yielding support feet (11), interposed between said frame (7) and said surface (8).

3. A device (1) according to claim 1, characterized in that said transducer (10) does not belong to the axis of said fulcrum blade (9).

4. A device (1) according to claim 1, characterized in that said swinging support surface (8) comprises two lateral sidewalls (17).

5. A device (1) according to claim 1, characterized in that said frame (7) comprises at least one arc-shaped cross guide (26), arranged for slidingly engaging at least one pair of wheels (12) associated with said fixed base (3).

6. A device (1) according to claim 1, characterized in that said transmission means comprise a selectively activated clutch (13) placed downstream of said motor means (5).

7. A device (1) according to claim 6, characterized in that said device (1) comprises manual movement means (14) of said transmission means.
